(19) United States
(12) Patent Application Publication
(10) Pub. No.: US 2018/0288364 A1
(43) Pub. Date: Oct. 4, 2018

(54) Method and system for sensory environment replication

(71) Applicant: Zen-me Labs Oy, Tampere (FI)

(72) Inventor: Toni Matti Virhiä, Tampere (FI)

(73) Assignee: Zen-me Labs Oy, Tampere (FI)

(21) Appl. No.: 15/473,633

(22) Filed: Mar. 30, 2017

(51) Int. Cl. H04N 5/92; G11B 27/34

(52) U.S. Cl. CPC H04N 5/9201; G11B 27/34

(57) ABSTRACT

A method for reproducing an environment by replicating characteristics of an event. The method includes replicating, in place of simulating, the characteristics of an event by first capturing characteristics via a plurality of sensors in an environment and producing playback instructions for replicating the characteristics, based on recorded data of the actual characteristics, on playback devices. The characteristics can be both kinetic and non-kinetic to give a more accurate and whole replication of the event to a user.

### TECHNICAL FIELD

The invention concerns in general the technical field of reproducing a perception of an actual environment by replicating. Especially the invention concerns reproducing an actual environment or event in the past by replicating utilizing data recorded representing the characteristics of the environment.

### BACKGROUND

Nowadays smart phones and mobile devices with cameras and microphones have become increasingly common and part of everyday lives. Devices such as these allow users to easily share photos, videos and audio recordings with other people. There are many different platforms on which, for example, the photos taken by the users may be shared with others, such as Facebook™ or Instagram™.

Social media usage continues to increase and diversify, and users look to share not only their personal comments and photos, but their interactions with the surroundings and their environment. To do this sensors are being developed that allow users to monitor and share eating, sleeping, and exercise habits. There are also numerous wireless sensors and home automation devices that allow users to monitor and control temperature, humidity, ambient light, etc. Many of these sensors communicate through various applications over wireless network and/or the internet and allow users to monitor these sensors and often control lights, thermostats, alarms, etc.

Augmented reality is a real-time or at least near real-time direct or indirect view of the physical world having elements that are augmented, typically, by using a computer. Typical augmented reality application is such that a video is taken and shown live for users and the video is simultaneously supplemented by computer-generated elements such as audio, graphics, positioning data or the like. While the video captured is partly a presentation of the perceived reality, the augmented elements are created artificially. Augmented reality is thus only partly reality in the sense that the user does not experience all the elements, especially the augmented elements, as they are or would have been experienced, if the user would have been present in the environment target of the augmented reality.

Video games, on the other hand, may be a form of virtual reality, if an actual place is modelled for a video game. Video games are not, in strict sense, reality because different elements are created by a programmer and thus do not represent actual events in the actual environment. There may be, for example, recorded sound of wind utilized in the video game but still the sound has been recorded in one place and the programmer decides when and at which intensity the sound is being replayed in the video game. Thus the “reality” is not in fact reality in all parts but merely a result of conscious design by the programmer.

There are also some attempts such as flight simulators in which a replicate of the cockpit of a real aircraft is built thus giving a perception of an actual flight. This is, however, an example of virtual reality with additional means for sensory perception, that is, tactile perception in the form of controllers in the cockpit replicate and the replication of the position of the aircraft and even acceleration/deceleration.

There is still need, however, for a solution for reproducing an actual environment or an actual event occurred in the actual environment which is then perceived as authentically as possible by a user and which may be, for example, shared with other users.

### SUMMARY

A method for reproducing an environment by replicating characteristics of an event. The method includes replicating, in place of simulating, the characteristics of an event by first capturing characteristics via a plurality of sensors in an environment and producing playback instructions for replicating the characteristics, based on recorded data of the actual characteristics, on playback devices. The characteristics can be both kinetic and non-kenetic to give a more accurate and whole replication of the event to a user.

A method for reproducing an environment or event may include some or all of the following steps, registering a plurality of sensors in an environment with a linking device, recording a plurality of characteristics of an event in the environment with the plurality of sensors, converting recorded data from the plurality of sensors about the characteristics of the event to playback instructions, wherein the playback instructions are capable of causing at least one playback device to replicate a characteristic of the event in a new environment, synchronizing the playback instructions based on the registration of the plurality of sensors and the recorded data from the plurality of sensors, wherein the synchronized playback instructions are capable of replicating at least one kinetic aspect of the event and at least one non-kinetic aspect of the event, in the new environment, through the synchronized use of a plurality of playback devices.

Furthermore, disclosed herein are systems and a method for reproducing an environment by replicating. The system and method for reproducing the environment by replicating can be used by a user to relive the environment as it was during the time period when the data utilized to create the replication were obtained.

According to an aspect of embodiments of the present invention, a method for reproducing an environment by replicating is provided. The method comprises obtaining a plurality of data related to a plurality of the characteristics of the environment recorded during a first time period by a plurality of sensors comprised in the environment. The method also comprises synchronizing temporally at least two of the plurality of the obtained data with respect to each other, the synchronized data representing at least two of the plurality of characteristics of the environment. The method further comprises creating a replication by utilizing the synchronized data as input for a replication model in an electronic computing apparatus configured to reproduce the environment with respect to the at least two of the plurality of characteristics of the environment and associated perceived sensory experience retaining the synchrony of the input data. The method also comprises storing the replication in a data structure on an electronically accessible data storage, for running by a user having at least one playback device capable of reproducing the environment with respect to at least one of the at least two of the plurality of characteristics of the environment.

Further, the method may comprise obtaining the plurality of data related to multiple classes of sensory perception of the environment. The multiple classes of sensory perception may comprise visual, audio, taste, smell, touch, temperature, balance, vibration, pain, kinesthetic sense.

The method may comprise the replication model to reproduce a characteristic of the environment by utilizing the synchronized data related to said characteristic of the environment to produce a perception of said characteristic for the user running the replication with the at least one playback device capable of producing the perception.

The method may comprise the replication model to produce the perception in different class of sensory perception with respect to the class of sensory perception related to the synchronized data related to said characteristic of the environment.

Further, the method may comprise the plurality of sensors being paired exclusively with a link device, wherein the plurality of sensors transmits the plurality of data to the link device.

The plurality of data may comprise at least two of the following: visual data, audio data, thermal images or video, temperature data, structural data, humidity, ambient light, irradiance, radiation, vibration, motion, acceleration, position, pH, moisture, pressure, time, air or fluid flow velocity.

The plurality of sensors may comprise at least two of the following: camera, microphone, thermal camera, temperature sensor, structure sensor, humidity sensor, photodetector, radiation sensor, tactile sensor, vibration sensor, Pitot tube sensor, motion sensor, inertial sensor, positioning sensor, accelerometer, gyroscope, pH sensor, pressure sensor, aerial photographing device, magnetic sensor.

The at least one playback device may comprise at least one of the following: a display or screen, a stereoscopy, headphones, a speaker, a haptic or tactile suit or vest, a humidity controlling device, a temperature controlling device, 3D goggles, virtual reality goggles.

According to another aspect of certain embodiments the present invention, systems for reproducing an environment by replicating are provided. The systems comprise an electronic computing apparatus obtaining a plurality of data related to a plurality of characteristics of the environment recorded during a first time period by a plurality of sensors comprised in the environment. The systems also comprise synchronizing temporally at least two of the plurality of data with respect to each other, the synchronized data representing at least two of the plurality of characteristics of the environment, wherein the central processing unit creates a replication by utilizing the synchronized data as input for a replication model in the electronic computing apparatus configured to reproduce the environment with respect to the at least two of the plurality of characteristics of the environment and associated perceived sensory experience retaining the synchrony of the input data. The systems further comprise a data storage storing the replication for running by a user having at least one playback device capable of reproducing the environment with respect to at least one of the at least two of the plurality of characteristics of the environment.

The system may comprise the plurality of sensors obtaining the plurality of data related to multiple classes of sensory perception of the environment.

The at least one playback device may be a dedicated playback system such as a flight simulator.

According to yet another aspect of embodiments of the present invention, there may be a computer program product, stored on a non-transitory electronically accessible storage medium, the computer program product, when executed on a computer, causes the computer to perform the method according to any method disclosed herein.

The expression “a number of” refers herein to any positive integer starting from one, e.g. to one, two, or three.

The expression “a plurality of” refers herein to any positive integer starting from two, e.g. to two, three, or four.

The terms “first”, “second”, “third” and “fourth” do not denote any order, quantity, or importance, but rather are used to distinguish one element from another.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

### BRIEF DESCRIPTION OF FIGURES

The embodiments of the invention are illustrated by way of example, and not by way of limitation, in the figures of the accompanying drawings.

FIG. 1 illustrates schematically a system according to certain embodiments of the present invention.

FIG. 2 illustrates schematically a system according to certain embodiments of the present invention.

FIG. 3 illustrates schematically a flow diagram of a method according to certain embodiments of the present invention.

FIG. 4 illustrates an example of the use of the method and system in accordance with an embodiment of the present invention.

### DETAILED DESCRIPTION OF CERTAIN EMBODIMENTS

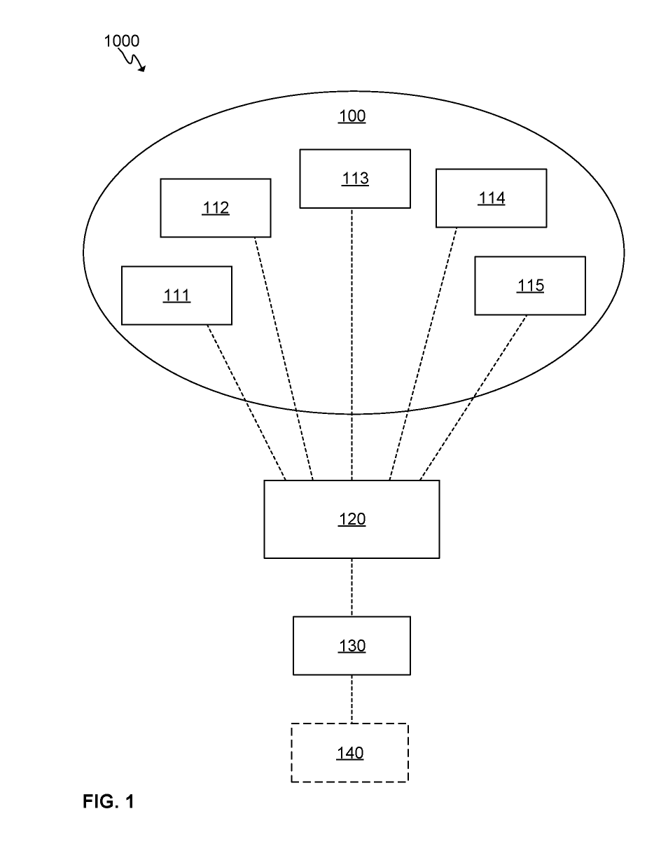

FIG. 1 illustrates schematically a system 1000 for reproducing an environment 100, or an event in the environment 100, or a perception of the environment 100 by replicating in accordance with an embodiment of the present invention. Environment, event of or in an environment or perception of an environment can be used interchangeably herein. The system 1000 may comprise a link device 120, one or several sensors 111-115 comprised in the environment 100, and a data storage 130 into which the replication may be stored for running by a user. There may also be at least one playback device 140 or a dedicated playback system 140 for running the replication of the environment 100 in order to reproduce the environment 100 or the event occurred in the environment 100 or a perception of the environment 100 for a user to experience as it was experienced or would have been experienced during a time period represented by the obtained plurality of data. A playback system and playback device are equivalent to an output system or output device herein.

According to certain embodiments of present invention, a sensor 111-115 or a sensor network may include a series of proprietary sensors, third party sensors, controllable switches, cameras, etc. or other devices. It is to be understood, that the term sensors as used herein may include sensors for gathering data from the environment 100 or the surroundings of the sensors 111-115, as well as controllable switches, cameras, proximity detector and other monitored devices. Sensors 111-115 may be deployed in many different environments 100, such as retail locations, aircrafts, cars, office buildings, storage buildings, boats, homes, offices, apartments, and/or mines or other harsh environments.

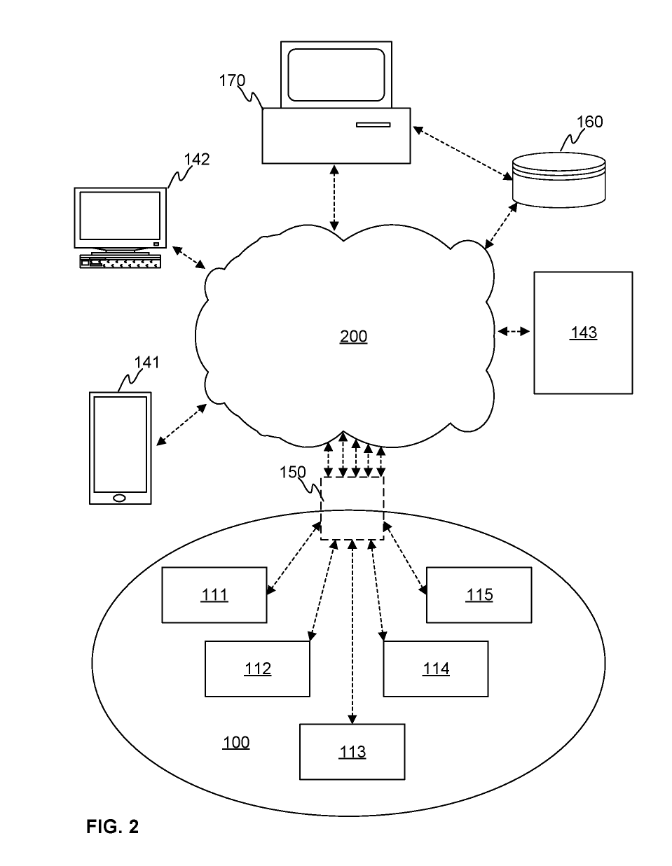

FIG. 2 illustrates schematically an embodiment of the present invention. The sensors may communicate to a network 200 directly or via a cellular network. The network 200 may be any wide area network (WAN) such as the internet which may then communicate with other networks. Network may be a private network with private storage capabilities or maybe a personal user network with personal storage capabilities. Network may include any one network or several networks, including a local area network (LAN), WAN or open source global network, public or private, or any combination thereof with access to the sensor platform coupled to the network, and the devices coupled to the network, are included in such reference.

According to certain embodiments of the present invention, as also shown in FIG. 2, a general computer architecture may be utilized to implement an embodiment of the present invention. The computer 170 may be a general purpose computer or a special purpose computer. The computer 170 may be used to implement any components of the systems and methods as described herein. For example, the secure storage, the network, the replication models may all be implemented on a computer, via its hardware, software program, firmware, or a combination thereof. Although only one such computer 170 is shown, for convenience, the computer functions relating to reproducing the environment by replicating may be implemented in a distributed fashion on a number of similar platforms, to distribute the processing load.

The computer includes, for example, COM ports connected to and from a network 200 connected thereto to facilitate data communications. The computer 170 may also include a central processing unit (CPU), in the form of one or more processors, for executing program instructions. The exemplary computer platform includes an internal communication bus, program storage and data storage of different forms, e.g., disk, read only memory (ROM), or random access memory (RAM), for various data files to be processed and/or communicated by the computer, as well as possibly program instructions to be executed by the CPU. The computer 170 may also include an I/O component, supporting input/output flows between the computer and other components therein such as user interface elements. The computer may also receive programming and data via network communications.

Hence, aspects of the system according to certain embodiments may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated devices thereof, such as various semiconductor memories, tape drives, disk drives and the like, which may provide storage at any time for the software programming.

All or portions of the software may at times be communicated through a network 200 such as the Internet or various other telecommunication networks. Such communications, for example, may enable loading of the software from one computer or processor into another, for example, from a server or host computer of the sensor social networking platform or other Digital Cinema Package (DCP) service provider into the hardware platform(s) of a computing environment or other system implementing a computing environment or similar functionalities in connection with generating the sensor social networking platform. Thus, another type of media that may bear the software elements includes optical, electrical and electromagnetic waves, such as used across physical interfaces between local devices, through wired and optical landline networks and over various airlinks. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and IR data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

According to certain embodiments of the present invention, an playback device 140-142 or a dedicated playback system 143 may be, for example, a mobile phone 141, laptop, personal computer 142, or a flight simulator 143 or similar 143. The dedicated playback system, such as a flight simulator 143, may be designed for consumers or professionals and/or be of an industrial scale system. According to certain embodiments, the playback device may be a haptic vest or suit.

It should be understood that all of the disclosed systems and methods may be performed by a distributed system. Such a distributed system may be based on a LAN operating within a single location, a WAN encompassing several locations, or an open systems network such as the Internet. It should be further understood that devices used in accordance with the present invention may couple directly or indirectly, through wired or wireless communications to a global network, and the network may comprise a private network.

According to certain embodiments of the present invention, the sensors communicate via a short range communications technology such as Bluetooth™ or Bluetooth Low Energy™ (BLE), ZigBee™, Ru-Bee™, infrared (IR), Wi-Fi™, through a personal communications device such as a link device or through a mobile communications device to a network. The link device may be a personal gateway for transmitting the data obtained by the sensors to a network.

In an embodiment, the data obtained or recorded by the sensors may be communicated to a network 200 which may store the information in a proprietary storage 160 or in a personal storage 160. Personal storage may include, but is not limited to a dedicated personal hardware space on a personal network, a home network a personal cloud storage space or any storage space dedicated to the user. A proprietary storage may include a storage provided by a communications provider, the sensor provider, the sensor platform provider or any combination thereof.

According to certain embodiments of the present invention, the sensors may be configured especially to include an ability to keep the data gathered by the sensors secure and private. This may be accomplished by uniquely pairing sensors with link devices 150, personal communications devices and storage locations. By pairing the devices they can only communicate with their paired components, as such, the data will remain secure throughout the network because the data cannot be intercepted by a device that has not previously been associated with the specific system components.

According to certain embodiments of the present invention, each sensor and link device has a unique multi-digit identifier/identification/identity (ID) number associated with it. The multi-digit ID number or “silicon ID” is hard wired into a hardware component that stores the ID number by hardware. In an embodiment, the ID number is hardwired into a chip using a one-time programmable (OTP) fuse method. In this embodiment, the component has a number of fuses that are permanently blown to either represent a 0 or 1 and the code is this way burned by the number of fuses into the component. In this manner, the hard wired ID number cannot be altered any way. Each component with a multi-digit ID number is unique based on the ID number they represent to the system. A database of the unique ID numbers may be maintained in a secure database. This allows the network to confirm the pairing of devices based on the unique ID numbers. It is to be understood, that the secure database of ID numbers must be maintained in such a manner as to not allow access to the unique device ID data.

According to certain embodiments of the present invention, once a user has paired a sensor with a link device 150 or other such device, the sensor data will be maintained by the user in a data storage such a secure storage in network or in the user's personal storage. This data may also be selectively shared with other users if the data owner so chooses. In this way, users may share and use data generated by other users, thereby creating a social network of sensor data users. This sharing of data allows others a view into the “real world” of their contacts on the sensor network, prompting an exchange of real world information about each other. By sharing data between users, a users “virtual” network is greatly expanded. For example, a user who wishes to know the humidity in a given area does not need to place his or her own humidity sensor in that area if another user is willing to share data from a humidity sensor already placed in that area. This creation of an expanded “virtual” network expands the scope and amount of data available to a user and the social community as a whole.

Devices used in the system according to certain embodiments of the present invention may take any number of different forms, including personal computers, notebook computers, palm-top computers, hand-held computers, smart devices, such as mobile phones, televisions, tablets, web appliances, and the like, and/or any device which is capable of receiving and processing digital data via a network connection.

According to certain embodiments of the present invention, the system may comprise a link device which connects sensors and other wireless devices, via a short range communications link, such as Bluetooth™, Bluetooth Low Energy™, ZigBee™, Ru-Bee™, IR, or Wi-Fi™ to backend systems via network, secure data storage, and a browser application. Bluetooth™ or BLE™ is generically used herein to refer to any short range communications link. Sensors and other devices may communicate via short range communications to a paired mobile device, such as a mobile phone or tablet which has client installed.

Link device 150 may be a personal privacy gateway and may communicate to network via Wi-Fi™ 3G, 4G, or any other over the air communications standard. Link device may have a position sensor such as a Global positioning system (GPS) receiver for maintaining and reporting its location and may have a multi-frequency transceiver for receiving and transmitting information wirelessly. Link device may be DC (direct current) powered via USB (Universal Serial Bus) port, induction, or any other charging means, and/or comprises an internal battery for back-up. Link device may interface with switch, off-grid switch or beacon in addition to the various sensors.

Switch is a remote controlled AC (alternating current) switch with energy measurement capabilities. Switch may allow other AC powered devices to be plugged into it, thereby providing power capabilities to the remote device. Off-grid switch may be a remote controlled switch with 12 VDC applications. Beacon may be a sensor type device used for proximity applications. In an embodiment, the link device enables interfacing of third party sensors.

Sensors are an integral component of the present invention. Sensors are typically used to measure one or more specific environmental characteristics or conditions and may also include video cameras, audio devices, thermal imaging devices, etc. The sensors according to certain embodiments communicate with a low energy short range communications protocols, such as BLE™ although other protocols are acceptable. Other protocols include but are not limited to standard Bluetooth™, ZigBee™, Ru-Bee™, Wi-Fi™ mobile data such as 3G/4G. According to certain embodiments, the sensors may be irreversible paired with a link device when in use. This pairing ensures privacy and prevents unintended monitoring. The system level privacy functionality between a sensor and the link device prevent a sensor's data from being intercepted and/or otherwise compromised.

Sensors may include, but are not limited to relative humidity and temperature, ambient light, vibration, motion, acceleration, magnetic field, sound and leak although many other sensors are contemplated. Some other sensors may include pH, moisture, video personal fitness, proximity, shock and pressure, time lapse, density, particle, visual, structure, molecular, seismic, air quality, etc. In some embodiments, sensors may be mounted in mobile platforms like flying autonomous sensor.

In some embodiments, the sensors have internal power sources such as rechargeable Lithium batteries, although other power sources such as traditional batteries (non-chargeable), capacitors, energy cells, or real-time energy harvesting such as electromagnetic, radio waves or induction may be contemplated. In an embodiment, the sensors comprise an internal solar cell for recharging or directly powering the sensor device.

In certain embodiments, the sensors have at least the following main hardware features. A low energy short range communications interface such as a BLE 4.1 interface which can be based on a CSR1012 type chip, although other chipsets and communication protocols are possible.

Each sensor may also have an internal antenna, memory such as an EEPROM (Electronically Erasable Programmable Read-Only Memory) to store application software as well as operating and other parameters, such as parameters related to the operation of the sensor. The memory may also be used to store the measured data by the sensor. It may be used as a buffer before transmitting the data to a link device or to a communication network.

In various embodiments each sensor may have an internal power source such as a battery as well as circuitry to enable a charging functionality. In an embodiment, an external power source is used, although due to the size of the sensors, such an external source is not the primary power source. In an embodiment, each sensor will have its own security and privacy functionality based on a unique internal authentication code assigned to each sensor. This authentication number may be a 32-bit hard wired serial number although other security and privacy criteria and configurations may be used.

In an embodiment, sensors may be able to harvest solar energy through the face of the sensor. The solar energy may be used to power the sensor directly and/or charge the internal power source. In some embodiments, the solar energy may be obtained from ambient light. Because of the need to harvest solar or ambient light, the face of the sensor may be configured to optimize the passage and/or collection of such solar or ambient light. Alternatively and/or additionally the sensor may have an integrated portion which is able to process solar and/or ambient light.

In some embodiments, a sensor may be a temperature and/or relative humidity sensor with the actual detector located on the inside of the sensor device. In an embodiment, the temperature and/or relative humidity will be detected from the air. In an embodiment a leak detector sensor may include a sensor that monitors and detects leakage or flooding of liquids. This may comprise an internal sensor, a surface mounted sensors or an external sensor. Additionally and/or alternatively, sensors may have an external contacts utilizing resistive detection between the contacts to detect leaks. Further, sensors may have external probes for placing in a location or environment, where placement of the sensor body is not possible.

In some embodiments, an accelerometer and/or a gyroscope may be deployed for measuring 2D (2-dimensional) and 3D (3-dimensional) motion. These sensors may also include detection of position or some predefined pattern, motion or amplitude. The accelerometer and/or gyroscope may be utilized to detect and measure vibrations.

According to certain embodiments of the present invention, a Pitot tube sensor may be used to measure fluid velocity such as velocity of air or water. Pitot tube sensors may be used advantageously in aircrafts, boats or anywhere where the velocity of air, such as due to wind, with respect to the environment 100 is of interest and/or used in the system for example as an input for a replication model.

In an embodiment, motion detectors are used to detect the motion of an object in proximity to the sensor. The detection may be based on passive IR-detection with a passive IR sensor or active IR detection. The motion sensor may also be based on thermal variations, changes in air current, and interruptions with electromechanical beams or waves.

An embodiment may include the use of an ambient light sensor which may detect changes in and/or the strength of ambient light through the front surface of the sensor. An audio or sound sensor may be used in an embodiment to detect absolute or relative levels of sound or may detect changes in the ambient sound levels. Such sensors may detect specific frequencies, audio patterns, or vocal recognition.

In an embodiment, proximity beacons as well as control devices are considered sensor type devices and may also employ BLE and energy harvesting hardware techniques similar to the sensors. Control devices may be either switch based or off-grid based. Switch based control devices may operate on AC voltage and may be employed to control other devices. Off-grid control devices may control devices used to control devices requiring DC power.

The switch control device, in an embodiment, has a BLE chipset, an internal antenna, memory, typically in the form of a EEPROM to store the application software and other parameters. The switch control device may utilize power from an AC power supply when connected with a main power source. In an embodiment, the switch control device will have one or more AC-sockets or receptacles for power output to the controlled device. The output is remotely controlled over BLE. The switch control device may be used to measure consumed power, regulate, detect and control power. Like sensors, the devices may comprise security and privacy functions based on internal authentication codes and additionally may comprise USB outputs for charging.

Off-grid switching devices may comprise a BLE chip set, an internal antenna, memory storage, and a DC power output. The DC output may be remotely controlled over the BLE connection. Like the switched control device, the off-grid device may monitor power usage, time of usage, consumption, etc. It may comprise security and privacy functionality based on a unique internal authentication code.

In an embodiment, sensors may be mobile either through dedicated programming and/or managed control or through autonomous control. In an embodiment, one such sensor may be a flying autonomous sensor with similar flying qualities to an airborne platform based sensor. The airborne based sensor may be mounted in an aerial platform intended for indoor use and in particular use, within a personal space, such as a home, warehouse, business or office. The flying autonomous sensor may be programmed to periodically take flight in a predetermined pattern to monitor and or sense conditions within a room, building, indoor structure, or any other controlled area. In an embodiment, the flying autonomous sensor is powered through an on board battery or other power device such as solar. The flying autonomous sensor may be charged thorough an induction type circuit or may have an onboard battery. It may also be charged through solar, radio frequency (RF), turbine, magnetic induction, or any other methods. In an embodiment, when not in flight, the flying autonomous sensor may rest on an induction type power charger and be available as required. The flying autonomous sensor may reside within a niche in a wall, on a shelf or in any other non-obtrusive location when not in flight.

In an embodiment, at a predetermined time or in response to another stimulus, the flying autonomous sensor may self-deploy to gather the required sensor data. Data that may be collected in this manner may include, but is not limited to, motion data, temperature data, ambient light data, noise data, or any other type of sensor data. In an embodiment, the flying autonomous sensor may gather and update structural 3D data of an indoor space as well as maintaining visual augmented reality of the indoor space. In this manner, due to its ability to change positions and views, the flying autonomous sensor is able to map and/or model the 3D the space it is monitoring. Such monitoring enables the flying autonomous sensor to interface with an augmented or virtual reality view of the space and allows the user or operator to interface with it and the space utilizing augmented reality glasses for example. Another example of the use of the flying autonomous sensor is to monitor changes in the indoor space. For example, the flying autonomous sensor can track and follow up objects and their movements within a dedicated space based on chronological visuals readings of the entire space and comparing that to past histories. In this manner, the flying autonomous sensor may be able to cover larger areas then fixed sensors and may further be able to isolate areas of interest to the user.

In an embodiment, the flying autonomous sensor may “learn” from the sensor data and accordingly adjust its flight path and or flight schedule. It is to be understood, that any small aerial or other flying platform may be used to deploy the sensor, or a series of flying platforms may be used alone or in conjunction to gather sensor data. In an embodiment, a number of airborne platforms may be deployed to gather noise data in a large area such as a warehouse, or air flow data. By simultaneously deploying multiple sensors, a clearer picture of the environment may be obtained. Similarly, in an office or home environment, an airborne sensor mounted on a micro-airborne platform may be used to help optimize, work flow, or space utilization, by tracking data over longer periods of time and adjusting to changing conditions. The airborne sensor may also contain other sensors to aid with the flight such as IR sensors, IR cameras, code scanners that can read bar codes or QR codes, laser sensors to detect flight paths, or distancing devices.

The privacy and security of an embodiment of the present system may be provided by a unique identifier in each node including in all sensors and/or switch devices. In an embodiment, the sensors each have a unique serial number that is used for irreversible pairing with the communications device or link device. In an embodiment, the sensor uses a one-time programmable (OTP) memory that stores the identifier keys.

In an embodiment a motion sensor may be utilized. The motion sensor utilizes one or more pyroelectric IR sensors to detect motion in the sensor's field of view. The sensor may comprise of one, two, three or more detection areas. The sensitivity of the sensor is relative to the physical area of the sensor. In an embodiment, the sensors utilize different software and different processing based on the number and size of the sensors. If a detector has one detection element for example, the software keeps track of the previous reading and implements some dynamic setting of the change in the threshold level. In the case of multiple detection areas the reading from each area can be compared to each other to detect motion. This gives some flexibility in detection algorithms. In a motion sensor with multiple detection elements, the individual elements may be polled in sequence. Additionally and/or alternatively, each sensor element, may trigger an interrupt when the signal exceeds pre-defined threshold levels. In a motion sensor, the sensor window in the front panel, must have good transmittance for wavelengths across the full spectrum and most preferable in the IR to ultra violet range. In some embodiments, the window and the sensor have additional optical features to collect light from the desired area. In an embodiment, the lens or face and any specialty regions may be optimized and require different properties to operate based on the sensor operation. Separate units allow the uses to change the cover material into anything special that the sensor unit might require.

In an embodiment, an ambient light sensor detects illumination and ambient light on a scale of lumens/square meter or LUXs. In an embodiment, the sensor can detect from pitch dark to direct sunlight or a range from 0 to 100,000 Lux.

In an embodiment, the sound sensor can detect sound pressure (volume) and compare it to predefined threshold limit. The sensor's electronics may comprise a microphone, microphone amplifier, rectifier/integrator stage and comparator and buffer amplifier depending on the signal processing. In an embodiment, the sound sensor may require a separate host processor. In an embodiment, if more advanced signal processing is needed the audio signal may be interfaced to a host processor that has faster sampling rates and more memory available for the audio samples.

In an embodiment, a control switch maybe implemented as a sensor and will be based on the BLE chipset. Instead of requiring it to use solar power or energy harvesting, the control switch may use a regulator AC/DC circuit to use the power from the main source. Because of the additional and different circuitry, the dimensions (width and length) may be different than the other sensors.

According to certain embodiments of the present invention, all or some of the sensors comprised in the environment may be wearable. Especially, if a camera is utilized to record visual data, it may be arranged in a wearable manner on a person present in the environment 100.

According to certain embodiments of the present invention, the user can expand and grow the number of sensors or their sensor network in the environment by providing more and different sensors at different locations. According to certain embodiments of the present invention, the sensors may be capable of transmitting the measured data to other sensors before the data is transmitted to a link device or to a network for being stored on a data storage. In the above-described manner, the distance between any one single sensor and a link device or mobile device can be greatly extended. Additionally and/or alternatively, the power expended by each individual sensor can be greatly reduced because each on only has to transmit over a short range.

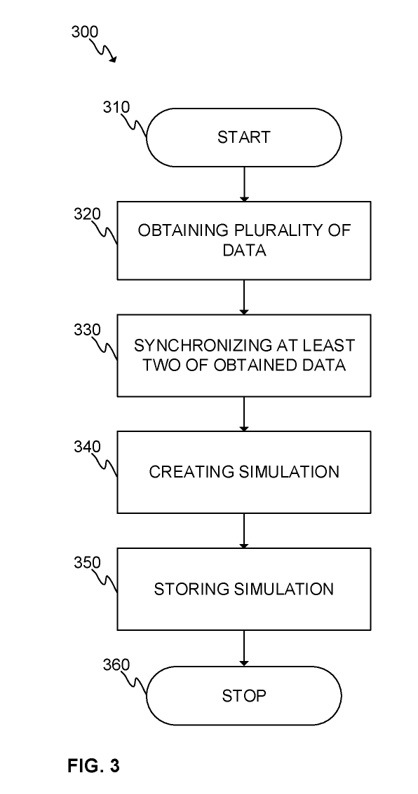

FIG. 3, at 300, illustrates a flow diagram of a method according to certain embodiments of the present invention.

Item 310 refers to a start-up phase of the method. At this step systems comprising the necessary equipment for reproducing an environment 100 by replicating are obtained and configured along with essential data connections.

At 320, a plurality of data related to a plurality of the environment characteristics recorded during a first time period by a plurality of sensors comprised in the environment are obtained.

According to certain embodiments of the present invention, the first time period may range from less than 0.1 seconds to multiple days, depending on the capability of the system to store data.

At 330, at least two of the plurality of the obtained data is temporally synchronized with respect to each other. The synchronized data represents at least two of the plurality of characteristics of the environment.

At 340, a replication by utilizing the synchronized data as input for a replication model in an electronic computing apparatus is being created. The replication is being configured to reproduce the environment with respect to the at least two of the plurality of characteristics of the environment and associated perceived sensory experience retaining the synchrony of the input data.

At 350, the replication is stored in a data structure on an electronically accessible data storage. The replication is suitable for being run by a user having at least one playback device capable of reproducing the environment with respect to at least one of the at least two of the plurality of characteristics of the environment.

Method execution is ended at 360. As a result of the method according to certain embodiments of the present invention, the replication reproducing an environment or an event in the environment during a first time period is being reproduced. The replication is further possible to be run by the person owning the data or a user with which the person has shared the replication.

According to certain embodiments, the replication model may comprise a physics engine utilizing the obtained data as input for reproducing the environment 100 or a perception of the environment 100.

The plurality of data may relate to multiple classes of sensory perception of the environment. The multiple classes of sensory perception may comprise, for example, at least one of the following: visual, audio, taste, smell, touch, temperature, balance, vibration, pain, kinesthetic sense.

According to certain embodiments of the present invention, the creation of the replication comprises the replication model to reproduce a characteristic of the environment by utilizing the synchronized data related to the characteristic of the environment in question to produce a perception of that characteristic for the user running the replication with the at least one playback device capable of producing the perception.

According to one embodiment of the present invention, the replication model produces the perception in different class of sensory perception with respect to the class of sensory perception related to the synchronized data related to that characteristic of the environment. This may entail, for example, measuring wind speed and then producing the effect of the wind speed on, for example, a sailboat as showing the position of the sailboat with respect to vertical and horizontal directions.

According to certain embodiments, the playback device or system may comprise means for controlling at least one of the following: humidity, temperature, ambient air or fluid pressure, motion of ambient air or fluid, light conditions, sounds. There may be other playback devices as well for reproducing the characteristic of the environment corresponding to the characteristic measured or represented by measurements of a sensor or a combination of sensors.

In an embodiment, an environment 100 or an event simulated may be shared with other users which may then provide comments, post and add updates about the environment 100 or event and generally discuss and share the data or replications. Comments on the sensor data maybe in the form of text, pictures, links, or any other format. Users with access to a replication may interact in a social network aspect with the data and/or the data's owner to provide insight, updates, and commentary based on the data.

In an embodiment, the sensor data or replication or data stream is presented in a timeline format in chronological order. Associated with that data are any corresponding comments and posts shared by the user and or any of the user's contacts that have access to that data.

In an embodiment, the user is able to manage the data, replications and information about his or her activities or events in real life via the streamed sensor updates from the user's private network of sensors.

In an embodiment, the timeline presentation of data allows users to comment and share information in chronological format based on the network sensor data. As the data is gathered, the information is conveyed to the secure storage and is identified with a universal time indicator. Time indicators may be provided from the GPS information or may be generated based on a system wide or network wide timing mechanism. In an embodiment the sensor data owner may decide how the sensor data or the replications are shared. The data owner may set commenting levels and permissions as well. For example, a user that shares data with select members within a group may allow those users to comment on the data and to share those comments with others that have access to that data. Additionally and/or alternatively, those users may be able to post comments which are viewable by a subgroup of users or the data owner only. In another embodiment, the data may be sharable with all users. Still further, the activity data or a replication may be shared only once by using a “Share Once” function. Such a function allows a user to share a moment of personal sensor data without having to share the full history or to allow future sensor data to be shared.

In an embodiment, the data or the replications or even the replication models may be monetized. This may be done by auction, bulk purchase, criteria purchase, targeted user data purchases, etc. However, because the data is indexed as it is catalogued, the granularity of data purchases of user information is easy and efficient.

According to certain embodiments there is a method for reproducing an environment of an event. The method may comprise some or all of the following steps: registering a plurality of sensors in an environment with a linking device, recording a plurality of characteristics of an event in the environment with the plurality of sensors, converting recorded data from the plurality of sensors about the characteristics of the event to playback instructions, wherein the playback instructions are capable of causing at least one playback device to replicate a characteristic of the event in a new environment, synchronizing the playback instructions based on the registration of the plurality of sensors and the recorded data from the plurality of sensors, wherein the synchronized playback instructions are capable of replicating at least one kinetic aspect of the event and at least one non-kinetic aspect of the event, in the new environment, through the synchronized use of a plurality of playback devices.

Methods may further include converting playback instructions for use with a specific type of playback device, wherein the converted playback instructions are synchronized with playback instructions for other playback devices. Still yet they may include creating replication data by utilizing the synchronized playback instructions as input for a replication model in an electronic computing apparatus configured to reproduce the event with respect to at least two of the plurality of characteristics of the event and an associated perceived sensory experience retaining the synchrony of the input data. Another step may be storing playback instructions and/or replication data in a data structure on a non-transitory electronically accessible data storage for running by a user having at least one playback device capable of reproducing the environment with respect to at least one of the at least two of the plurality of characteristics of the environment.

Examples of kinetic characteristics are touch sensation, vibration, pain, pressure, pressure wave, kinesthetic sense or temperature. Examples of non-kinetic aspect is at least one of: visual, audio, smell or taste. One of ordinary skill in the art will recognize additional examples of kinetic and non-kinetic characteristics and associated sensors which are not included here but which none the less do not depart from the scope of the present invention.

One or more playback instructions for a characteristic can be based on data collected from sensor capable of capturing data relating to that characteristic of the event in the environment. One or more playback instruction can be capable of causing an accurate reproduction of a characteristic of the event within the capabilities of the playback device for playing back the characteristic. Playback instructions can be such that they do not include simulation of characteristics of the event which were not recorded by at least one of the plurality of sensors. For example, they only include replication of captured characteristics from the plurality of sensors.

The plurality of sensors can be paired exclusively with the linking device. At least one of the plurality of sensors or linking device can have a hard wired ID which is used in the pairing of a sensor with the linking device. The hard wired ID can be a one time fuse programable hard wired ID. The hard wired ID can include permanently blowing a plurality of fuses of the object to create the hard-wired ID. Examples of such pairing, sensors, linking devices and hard wired ID's can be found in U.S. application Ser. No. 14/631,602 which is incorporated in its entirety herein.

There can be a system for reproducing an environment of an event according to aspects of the present invention. The system can include some or all of the following: a plurality of sensors in an environment registered with a linking device, a processor of an electronic device coupled with a non-transitory computer readable medium including stored thereon a set of instructions for obtaining recorded data from the plurality of sensors about characteristics of the event and converting the recorded data to playback instructions, wherein the playback instructions are capable of causing at least one playback device to replicate a characteristic of the event in a new environment, synchronizing the playback instructions based on the registration of the plurality of sensors and the recorded data from the plurality of sensors, and wherein the synchronized playback instructions are capable of replicating at least one kinetic aspect of the event and at least one non-kinetic aspect of the event, in the new environment, through the synchronized use of a plurality of playback devices.

The plurality of sensors of a system can include at least one sensor capable of recording a kinetic characteristic of the event and at least one additional sensor capable of recording a non-kinetic characteristic of the event. The plurality of sensors can include at least two non-similar sensors of the following: camera, microphone, thermal camera, temperature sensor, structure sensor, humidity sensor, photodetector, radiation sensor, tactile sensor, vibration sensor, Pitot tube sensor, motion sensor, inertial sensor, positioning sensor, accelerometer, gyroscope, pH sensor, pressure sensor, aerial photographing device, magnetic sensor. By non-similar it is meant two of different types, e.g. a camera and a vibration sensor, and not simply two of the same types such as two cameras for recording the same visual event or characteristic.

A system may include a playback device or playback devices. The playback devices can include at least two non-similar playback devices of the following: a display or screen, a stereoscopy, headphones, a speaker, a haptic or tactile suit or vest, a humidity controlling device, a temperature controlling device, 3D goggles, virtual reality goggles.

Another system for reproducing an environment can include some or all of the following elements: an electronic computing apparatus for obtaining a plurality of data related to a plurality of characteristics of the environment recorded during a first time period by a plurality of sensors arranged in the environment, and synchronizing temporally at least two of the plurality of data with respect to each other, the synchronized data representing at least two of the plurality of characteristics of the environment, a central processing unit for creating replication data by utilizing the synchronized data as input for a replication model in the electronic computing apparatus configured to reproduce the environment with respect to the at least two of the plurality of characteristics of the environment and associated perceived sensory experience retaining the synchrony of the input data, wherein at least one characteristic is kinetic and at least one characteristic is non-kinetic and a data storage for storing the reproduction for running by a user having at least one playback device capable of reproducing the environment with respect to at least one of the at least two of the plurality of characteristics of the environment.

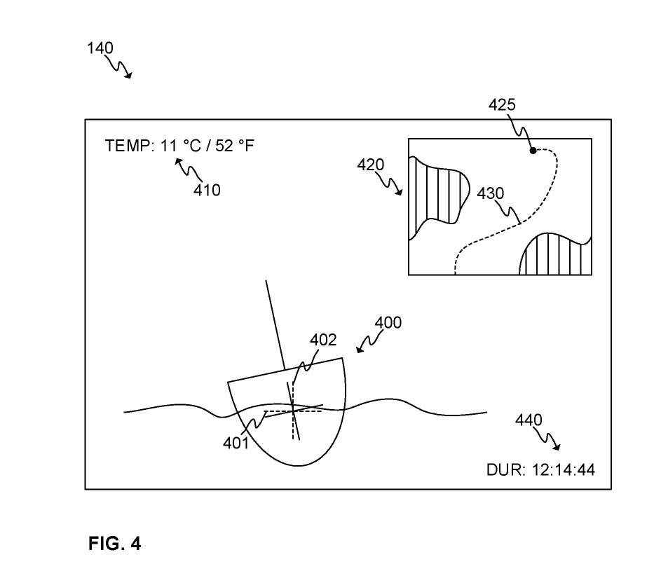

First example of the use of an embodiment of the method, also shown in FIG. 4, disclosed herein may be as described as follows. The sensors for obtaining a plurality of data related to a plurality of characteristics of the environment may be arranged on a sailboat. These sensors may include a sensor for measuring the speed of the boat, a GPS sensor for measuring the location of the boat, visual imaging sensors, such as a 3D camera, filming the environment, a temperature sensor, a humidity sensor, a barometer and a sensor for measuring the speed and direction of the wind. Advantageously, there may be a Pitot tube sensor. The sensors may be used to measure or obtain different parameter values of the characteristics of the environment of the sailboat. The plurality of data may be recorded during sailing, for example, during a sailboat racing.

The recorded or obtained data may be stored on a memory arranged within the sensor or it may be transmitted to a link device substantially immediately. The link device may preferably comprise enough memory for storing the plurality of data of the environment during time periods of minutes, hours or even days. The link device may process data such as by synchronizing it with respect to each other or with respect to at least some of the plurality of data. The link device may also transmit the plurality as such to another system which may then process the data, e.g., by performing synchronization.

The synchronized data may then be utilized for creating a replication by utilizing the synchronized data as input for a replication model of the sailboat and its movement and position and surrounding visual environment (including 3D model of the boat, for example, modeled with a structure sensor). The replication model may be configured to reproduce the environment of the sailboat, and the sailboat itself, with respect to all or at least some, e.g. two, of the plurality of characteristics of the environment of the sailboat measured or obtained in other ways. The replication model may, advantageously, comprise a physics engine taking into account the wind speed and its effect on the position and attitude of the boat.

The replication may then be run on an playback device, e.g., on a laptop or a mobile phone, by the sailor or some other user to which the sailor or the person in control of the plurality of data has shared the replication with. The user may then run the replication on the laptop or the mobile phone during running of which a model of the sailboat 400 with respect to horizontal 401 and vertical 402 directions may be illustrated in order to illustrate the position of the boat during, for example, a sailboat racing. The speed of the boat may be simulated by showing the speed value or indicating the speed by flowing water illustrated on the screen of the playback device. There may also be a map 420 showing the position 425 and path 430 of the boat during the racing. There may also be the duration 440 of the sailing visible on the screen. There may also be other data such as temperature 410 of the air or water visible on the screen of the playback device. The replication can be viewed with virtual reality goggles, replication including 3D environment and dynamic 3D model of the boat captured by the sensors indicating the position and attitude of the boat and sails at a particular time instance. The sailor or the user may then experience the sailboat racing and may, for example, evaluate the decisions made during the racing. The evaluation may then be used, e.g., for training purposes.

Second example of the use of the method disclosed herein may be as described as follows. The sensors for obtaining a plurality of data related to a plurality of characteristics of the environment may be arranged in a mine. These sensors may include a sensor for measuring the temperature, the humidity, the pressure inside the mine. There may also be a structure sensor for measuring spatially the space inside the mine. There may be a sensor for measuring light inside the mine such as a photodetector. The sensors may be used to measure or obtain different parameter values of the characteristics of the environment of the mine. The plurality of data may be recorded during a visit to the mine or by sensors arranged thereto during any time period with or without persons present in the mine. The data may be transmitted and/or stored, for example, as in the first example of the use of the method disclosed above.

The synchronized data may then be utilized for creating a replication by utilizing the synchronized data as input for a replication model of the mine. The replication model may be configured to reproduce the environment of the mine with respect to all or at least some, e.g. two, of the plurality of characteristics of the environment of the mine.

The replication may then be run on an playback device, e.g., on a laptop or a virtual glasses, by a user. The replication may also be run by a dedicated apparatus for replicating conditions inside the mine. These may include playback device for controlling the humidity and heat of the space in which the user is when running the replication. There may also be playback device for controlling the light inside the space.

According to certain embodiments of the present invention, in the second example, a driver of a mining vehicle, such as a loading machine, may practice driving inside the mine before actually entering the mine. The environment inside the mine may be reproduced by replicating by utilizing measured data inside the mine by the various sensors. The data may be utilized in a simulator to reproduce the environment 100. The simulator may comprise a replicate of the actual cabin of the loading machine with at least control equipment for controlling the movement of the loading machine. The driver may drive to loading machine in the reproduced simulated environment which may be outputted by the simulator and, for example, 3D virtual reality goggles. The reproduced environment 100 corresponds to the mine during the time period when the data was recorded. New data may be obtained and the environment simulated to corresponds to latest state of the mine which typically changes once the drilling inside the mine takes place. Thus the driver may practice to drive in the actual mine inside of which he may actually start working. Visual imaging sensors and/or photodiodes may be used to reproduce the environment so that in the replication the lighting conditions correspond to the actual lighting conditions inside the mine.

According to certain embodiments of the present invention, the recorded data and/or the replication of the environment may be used during the operating inside the actual mine by, for example, augmented reality goggles by showing such parameters as temperature, humidity, radiation, gas concentrations, etc.

Third example of the use of the method disclosed herein may be as described as follows. The sensors for obtaining a plurality of data related to a plurality of characteristics of the environment in which a person is experiencing and recording an event, such as in a concert, may include a visual sensor, such as camera or 3D camera, or an autonomous flying sensor having a structure sensor or a camera. There may also be microphones, tactile sensors such as a haptic vest or suit capable of measuring contact or pressure at different points on the surface of the vest or suit. The data may be transmitted and/or stored, for example, as in the first example of the use of the method disclosed above.

The data may be stored on a memory arranged within the sensor or it may be transmitted to a link device immediately. The link device may preferably comprise enough memory for storing the plurality of data of the environment during time periods of minutes, hours or even days. The link device may process data such as by synchronizing it with respect to each other or at least some of the plurality of data. The link device may also transmit the plurality as such to another system which may then process the data, e.g., by performing synchronization.

The synchronized data may then be utilized for creating a replication by utilizing the synchronized data as input for a replication model of the concert hall or space in which the concert is taking place.

The replication may then be run on an playback device, e.g., on a laptop or a mobile phone, by the person or a user with which the person is decided to share the experience with. The user running the stored replication may need to obtain, in addition to a laptop having a screen and speakers or, for example, a haptic vest or suit and 3D virtual goggles and headphones which properties corresponds to one that was used by the person recording the event in order to (re-)experience the concert as authentically as possible. The replication of the concert environment or the concert event may, advantageously, then be shared with other users which may experience the concert as realistically as possible with 3D goggles, speakers and a haptic vest, which may reproduce the sensation of the sound pressure.

Fourth example of the use of the method disclosed herein may be as described as follows. The sensors for obtaining a plurality of data related to a plurality of characteristics of the environment of commercial storage facility or a warehouse may include a visual sensor, such as camera or 3D camera, or an autonomous flying sensor having a structure sensor or a camera. The replication may relate, for example, to a near real-time replication of the storage contents. The data may be transmitted and/or stored, for example, as in the first example of the use of the method disclosed above.

The data may be stored on a memory arranged within the sensor or it may be transmitted to a link device immediately. The link device may preferably comprise enough memory for storing the plurality of data of the environment during time periods of minutes, hours or even days. The link device may process data such as by synchronizing it with respect to each other or at least some of the plurality of data. The link device may also transmit the plurality as such to another system which may then process the data, e.g., by performing synchronization.

The synchronized data may then be utilized for creating a replication by utilizing the synchronized data as input for a replication model of the storage facility or warehouse.

The replication may then be run on an playback device, e.g., on a laptop or a mobile phone, by the person or a user with which the person is decided to share the experience with. The user running the stored replication may need to obtain, for example, a laptop having a screen and speakers or 3D virtual goggles. The replication of the storage facility may, advantageously, then be used to monitor the current state of the storage facility, that is, whether the pallet racks are full or empty as well as the size of the pallets and/or the packets on the pallets. The replication may then be utilized similarly to the second example related to the mine such as to practice driving inside the storage facility or warehouse with a warehouse vehicle.

Those skilled in the art will recognize that the present teachings are amenable to a variety of modifications and/or enhancements. For example, although the implementation of various components described above may be embodied in a hardware device, it can also be implemented as a software only solution e.g., an installation on an existing server. In addition, the sensor social networking platform and its components as disclosed herein can be implemented as a firmware, firmware/software combination, firmware/hardware combination, or a hardware/firmware/software combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation and thus the specific examples provided in the description given above should not be construed as limiting the applicability and/or the interpretation of the appended claims. Lists and groups of examples provided in the description given above are not exhaustive unless otherwise explicitly stated.

1. A method for reproducing an environment or event, comprising;
registering a plurality of sensors in an environment with a linking device,
recording a plurality of characteristics of an event in the environment with the plurality of sensors,
converting recorded data from the plurality of sensors about the characteristics of the event to playback instructions, wherein the playback instructions are capable of causing at least one playback device to replicate a characteristic of the event in a new environment,
synchronizing the playback instructions based on the registration of the plurality of sensors and the recorded data from the plurality of sensors,
wherein the synchronized playback instructions are capable of replicating at least one kinetic aspect of the event and at least one non-kinetic aspect of the event, in the new environment, through the synchronized use of a plurality of playback devices.

2. The method of claim 1, further comprising:
converting playback instructions for use with a specific type of playback device, wherein the converted playback instructions are synchronized with playback instructions for other playback devices.

3. The method of claim 1, further comprising:
creating replication data by utilizing the synchronized playback instructions as input for a replication model in an electronic computing apparatus configured to reproduce the event with respect to at least two of the plurality of characteristics of the event and an associated perceived sensory experience retaining the synchrony of the input data.

4. The method of claim 1, further comprising:
storing playback instructions and/or replication data in a data structure on a non-transitory electronically accessible data storage for running by a user having at least one playback device capable of reproducing the environment with respect to at least one of the at least two of the plurality of characteristics of the environment.

5. The method of claim 1, wherein the kinetic aspect is at least one of: touch sensation, vibration, pain, pressure, pressure wave, kinesthetic sense or temperature.

6. The method of claim 1, wherein the non-kinetic aspect is at least one of: visual, audio, smell or taste.

7. The method of claim 1, wherein each playback instruction for a characteristic is based on data collected from sensor capable of capturing data relating to that characteristic of the event in the environment.

8. The method of claim 1, wherein each playback instruction is capable of causing an accurate reproduction of a characteristic of the event within the capabilities of the playback device for playing back the characteristic.

9. The method of claim 8, wherein the playback instructions do not include simulation of characteristics of the event which were not recorded by at least one of the plurality of sensors.

10. The method of claim 1, wherein the plurality of sensors are paired exclusively with the linking device.

11. The method of claim 1, wherein at least one of the plurality of sensors or linking device has a hard wired ID which is used in the pairing of a sensor with the linking device.

12. The method of claim 11, wherein the hard wired ID is a one time fuse programable hard wired ID.

13. The method of claim 12, wherein the hard wired ID includes permanently blowing a plurality of fuses of the object to create the hard-wired ID.

14. A system for reproducing an environment or event, comprising;
a plurality of sensors in an environment registered with a linking device,
a processor of an electronic device coupled with a non-transitory computer readable medium including stored thereon a set of instructions for obtaining recorded data from the plurality of sensors about characteristics of the event and converting the recorded data to playback instructions, wherein the playback instructions are capable of causing at least one playback device to replicate a characteristic of the event in a new environment, synchronizing the playback instructions based on the registration of the plurality of sensors and the recorded data from the plurality of sensors, and wherein the synchronized playback instructions are capable of replicating at least one kinetic aspect of the event and at least one non-kinetic aspect of the event, in the new environment, through the synchronized use of a plurality of playback devices.

15. The system of claim 14, wherein the plurality of sensors includes at least one sensor capable of recording a kinetic characteristic of the event and at least one additional sensor capable of recording a non-kinetic characteristic of the event.

16. The system of claim 15, wherein the plurality of sensors includes at least two non-similar sensors of the following: camera, microphone, thermal camera, temperature sensor, structure sensor, humidity sensor, photodetector, radiation sensor, tactile sensor, vibration sensor, Pitot tube sensor, motion sensor, inertial sensor, positioning sensor, accelerometer, gyroscope, pH sensor, pressure sensor, aerial photographing device, magnetic sensor.

17. The system of claim 14, further including a playback device including at least two non-similar playback devices of the following: a display or screen, a stereoscopy, headphones, a speaker, a haptic or tactile suit or vest, a humidity controlling device, a temperature controlling device, 3D goggles, virtual reality goggles.

18. A system for reproducing an environment comprising:
an electronic computing apparatus for obtaining a plurality of data related to a plurality of characteristics of the environment recorded during a first time period by a plurality of sensors arranged in the environment, and synchronizing temporally at least two of the plurality of data with respect to each other, the synchronized data representing at least two of the plurality of characteristics of the environment,
a central processing unit for creating replication data by utilizing the synchronized data as input for a replication model in the electronic computing apparatus configured to reproduce the environment with respect to the at least two of the plurality of characteristics of the environment and associated perceived sensory experience retaining the synchrony of the input data, wherein at least one characteristic is kinetic and at least one characteristic is non-kinetic and
a data storage for storing the reproduction for running by a user having at least one playback device capable of reproducing the environment with respect to at least one of the at least two of the plurality of characteristics of the environment.
